(19) United States
(12) Patent Application Publication
(10) Pub. No.: US 2025/0225315 A1
(43) Pub. Date: Jul. 10, 2025

(54) MESSAGE PROCESSING METHOD, APPARATUS, ELECTRONIC DEVICE, AND STORAGE MEDIUM

(71) Applicant: Beijing Zitiao Network Technology Co., Ltd., Beijing (CN)

(72) Inventors: Zhi LI, Beijing (CN); Xintong SUN, Beijing (CN); Jiaxin LIU, Beijing (CN)

(21) Appl. No.: 18/853,864

(22) PCT Filed: Jun. 25, 2023
(86) PCT No.: PCT/CN2023/102076

§ 371 Date: Oct. 3, 2024

(30) Foreign Application Priority Data
Jun. 29, 2022 (CN) 202210764451.7

(51) Int. Cl. G06F 40/166; G06F 40/279

(52) U.S. Cl. CPC G06F 40/166; G06F 40/279

(57) ABSTRACT

The present application provides a message processing method, apparatus, an electronic device, and a storage medium. In response to messages sent by users in a conversation, aggregating a plurality of messages meeting an identical-message condition among the messages to form an aggregated message; replacing the messages meeting the identical-message condition with the aggregated message in the conversation and presenting the aggregated message.

### CROSS-REFERENCE TO RELATED APPLICATIONS

The present application is a U.S. National Stage application under 35 U.S.C. § 371 of International Application No. PCT/CN2023/102076, as filed on Jun. 25, 2023, which claims priority to the Chinese Patent Application No. 202210764451.7 filed with China National Intellectual Property Administration on Jun. 29, 2022, entitled “Message Processing Method, Apparatus, Electronic Device, and Storage Medium”, the disclosure of which is incorporated by reference herein in its entirety.

### TECHNICAL FIELD

The present application relates to the technical field of software, and in particular to a message processing method, apparatus, an electronic device, and a storage medium.

### BACKGROUND

Nowadays, the use of communications chat software for communication has become more and more popular. Through chat messages, effective information in the chat messages can be obtained quickly and intuitively.

### SUMMARY

In view of this, an object of embodiments of the present application is to propose a message processing method, apparatus, and an electronic device.

Based on the above object, an embodiment of the present application provides a message processing method, comprising:
in response to messages sent by users in a conversation, aggregating a plurality of messages meeting an identical-message condition among the messages to form an aggregated message;
replacing the messages meeting the identical-message condition with the aggregated message in the conversation and presenting the aggregated message.

In some optional embodiments, the aggregated message includes one or more of the following:
message content;
the number of the plurality of messages;
user information of the users who send the plurality of messages.

In some optional embodiments, if the plurality of messages include only text messages, it is judged whether a plurality of text messages exceeding a threshold contain the same text content; if yes, it is determined that the plurality of messages containing the same text content meet the identical-message condition, and the same text content is taken as message content of the aggregated message corresponding to the plurality of text messages.

In some optional embodiments, if a first text message meeting the identical-message condition includes other content in addition to the same text content, the aggregated message is presented and the first text message is presented.

In some optional embodiments, if the plurality of messages include both text messages and emoji messages, a keyword corresponding to each emoji message is determined;

It is judged whether the text messages contain the same text content, and whether the keyword corresponding to the emoji message is the same as the text content; or, a keyword corresponding to the emoji message is determined, and it is judged whether the text messages contain the keyword;
if yes, when the number of the text messages and emoji messages exceeds a threshold, it is determined that the text messages and the emoji messages meet the identical-message condition, and the keyword and/or a first emoji corresponding to the emoji messages are taken as message content of the corresponding aggregated message.

In some optional embodiments, after presenting the aggregated message, if a plurality of messages being identical with the previous aggregated message are further received after it is judged that a message interruption condition is met, the plurality of messages further received are re-aggregated to obtain a new aggregated message.

In some optional embodiments, after presenting the aggregated message, when messages meeting the identical-message condition are further received, it is judged whether a message interruption condition is met, and if not, the received messages are aggregated into the aggregated message.

In some optional embodiments, the method further comprises:
presetting at least one keyword corresponding to respective emojis;
if it is detected that the text messages entered by the users include a keyword corresponding to a second emoji, taking the second emoji and the text content corresponding to the text messages collectively as sending message options, so that the users select a corresponding message form to send to the conversation.

In some optional embodiments, detecting that the text messages entered by the users include a keyword corresponding to a second emoji comprises:
with a mouse cursor positioning point as a search cutoff point, searching for the text content before the cursor in the messages entered by the users, and matching it sequentially with the keywords corresponding to the respective emojis preset in the system; if the matching is successful, determining that the text messages entered by the users include the keyword corresponding to the second emoji that is matched successfully.

In some optional embodiments, if it is detected that the text messages entered by the users include keywords corresponding to a plurality of second emojis, the plurality of second emojis are provided as sending message options for the users to select.

In some optional embodiments, in response to a user-triggered aggregated message merging operation, the new aggregated message is merged with the previous aggregated message.

In some optional embodiments, presenting the aggregated message and presenting the first text message comprise:
increasing the number of times of messages in the aggregated message by 1, and presenting the first text message.

In some optional embodiments, if the plurality of messages meeting an identical-message condition include a plurality of messages sent by one and the same user, the number of times of messages corresponding to the plurality of messages sent by the one and the same user is 1.

In some optional embodiments, the method further comprises:
re-aggregating adjacent aggregated messages.

In some optional embodiments, the plurality of messages are all text messages;
or,
the plurality of messages include text messages and emojis.

Based on the same technical concept, an embodiment of the present application further provides a message processing apparatus, comprising:
an aggregation module configured to, in response to group messages sent by users in a group conversation, aggregate a plurality of messages that are continuous and meet an identical-message condition among the group messages to form an aggregated message;
a presentation module configured to replace the messages meeting the identical-message condition with the aggregated message in the group conversation and present the aggregated message.

Based on the same technical concept, an embodiment of the present application further provides an electronic device, comprising a memory, a processor, and a computer program stored in the memory and executable on the processor, wherein the processor, when executing the program, implements the method according to any one of the aspects described above.

Based on the same technical concept, an embodiment of the present application further provides a non-transitory computer-readable storage medium that stores computer instructions, wherein the computer instructions are configured to cause a computer to perform the method according to any one of the aspects described above.

Based on the same technical concept, an embodiment of the present application further provides a computer program product comprising computer program instructions, which, when running on a computer, causes the computer to perform the method according to any one of the aspects described above.

### BRIEF DESCRIPTION OF THE DRAWINGS

In order to more clearly illustrate the technical solutions of the present application or related art, the drawings used in the description of the embodiments or related art will be briefly introduced below. Obviously, the drawings in the description below are only embodiments of the present application, and for those skilled in the art, other drawings can be obtained according to the drawings without creative efforts.

FIG. 1 is a schematic diagram of an application scenario of a message processing method according to an embodiment of the present application;

FIG. 2 is a schematic diagram of a flow chart of a message processing method according to an embodiment of the present application;

FIG. 3 is a schematic diagram of an aggregated message according to an embodiment of the present application;

FIG. 4 is a schematic diagram of another aggregated message according to an embodiment of the present application;

FIG. 5 is a schematic structural diagram of a message processing apparatus according to an embodiment of the present application;

FIG. 6 is a schematic structural diagram of an electronic device according to an embodiment of the present application.

### DETAILED DESCRIPTION

In order to make the objectives, technical solutions and advantages of the present application more clearly understood, the present application will be further described in detail below in conjunction with specific embodiments and with reference to the accompanying drawings.

It should be noted that, unless otherwise defined, the technical terms or scientific terms used in the embodiments of the present application should have general meanings understood by persons with ordinary skills in the field to which the present application belongs. The words “first”, “second” and the like used in the embodiments of the present application do not indicate any order, quantity or importance, but are only used to distinguish different components. The word “including”, “comprising” or the like means that the element or article preceding the word comprises the element or article listed after the word and its equivalents, but does not exclude other elements or articles. The word “connecting” or “connected” or the like is not limited to physical or mechanical connections, but may include electrical connections, whether direct or indirect.

When there are numerous messages in a current chat group, there often appears a phenomenon that repeated messages flood the screen below the messages that require replies, resulting in low information efficiency. In order to solve this problem, in the related art, repeated emojis in chat messages within a chat group are collapsed. Herein, emojis (“ [symbol] ” in Japanese) are visual emotional symbols used in the Internet communications, wherein “ [symbol] ” refers to a picture, and “ [symbol] ” is the interpretation of the picture, which can be used to express a variety of emotions, such as smiley face for smile, cake for food, etc.

In the related art, when more than 3 identical emojis appear continuously in group chat messages, they will be collapsed into a card, and subsequently, if identical emojis are again sent after a period of time, they will still be collapsed into the card, until other content is sent within the group, which interrupts the collapse.

However, in the related art, only repeated emojis can be collapsed, while group messages still contain a large amount of text content, and when the text content is repeated, the repeated text cannot be collapsed, which also results in low group information efficiency.

In order to solve the aforementioned problem, an embodiment of the present application provides a message processing method, which, in response to messages sent by users in a conversation, aggregates a plurality of messages meeting an identical-message condition among the messages to form an aggregated message, replaces the messages meeting the identical-message condition with the aggregated message in the conversation and presents the aggregated message, so that repeated replies from multiple persons among the communication conversation messages can be displayed in an aggregated manner, thereby improving the efficiency of in-group information communication and avoiding excessive invalid information.

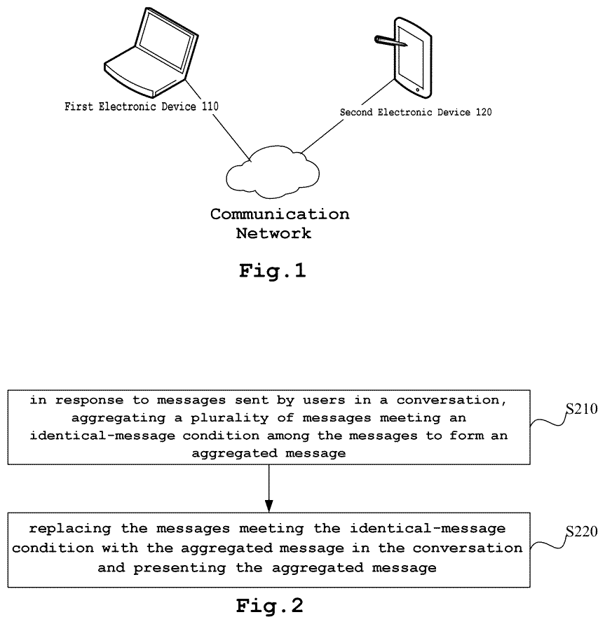

Reference is made to FIG. 1, which is a schematic diagram of an application scenario of a message processing method provided in an embodiment of the present application. The application scenario comprises a first electronic device 110 and a second electronic device 120, wherein the first electronic device 110 and the second electronic device 120 may be connected through a wired or wireless communication network. The first electronic device 110 and the second electronic device 120 are only used to distinguish different electronic devices and do not represent the number of electronic devices in the application scenario. In practical application, there may be a plurality of electronic devices. The first electronic device 110 or the second electronic device 120 comprises but is not limited to a desktop computer, a mobile phone, a mobile computer, a tablet computer, a media player, a smart wearable device, a personal digital assistant (PDA) or other electronic devices capable of realizing the above functions.

The first electronic device 110/the second electronic device 120 is installed with a client communicating with the second electronic device 120/the first electronic device 110. A user may enter a group conversation through the client and view the messages sent by other users. When there are a plurality of messages meeting an identical-message condition, the plurality of messages are aggregated to form an aggregated message, wherein the aggregated message includes message content, the number of times of merging messages, and user information; the messages meeting the identical-message condition are replaced with the aggregated message in the conversation and the aggregated message is presented, so that repeated replies from multiple persons among the communication conversation messages can be collapsed into one place, thereby improving the efficiency of in-group information communication and avoiding excessive invalid information.

In the following is described a message processing method according to an exemplary embodiment of the present application in conjunction with the application scenario of FIG. 1. It should be noted that the above application scenario is only shown to facilitate understanding of the spirit and principles of the present application, and the embodiment of the present application is not limited in this regard. On the contrary, the embodiment of the present application can be applied to any applicable scenarios.

FIG. 2 is a schematic diagram of a flow chart of a message processing method according to an embodiment of the present application. As shown in FIG. 2, the method comprises:

Step S210: in response to messages sent by users in a conversation, aggregating a plurality of messages meeting an identical-message condition among the messages to form an aggregated message.

Specifically, when a plurality of users send messages in a communication conversation, it is judged whether a plurality of messages meet the identical-message condition, wherein the plurality of messages may all be text messages or messages including both text messages and emojis. It is judged whether the messages meet the identical-message condition, such as whether they are all the same emoji, whether they are all the message “RECEIVED”, or the like. If yes, the plurality of messages being identical are aggregated to form an aggregated message, which includes one or more of message content, the number of the plurality of messages, and user information of the users who send the plurality of messages, wherein the message content, is for example, “RECEIVED” or the like, and the number of the plurality of messages is namely the number of identical messages sent.

Step S220: replacing the messages meeting the identical-message condition with the aggregated message in the conversation and presenting the aggregated message.

After determining the aggregated message, the messages meeting an identical-message condition may be replaced with the aggregated message in the conversation, and the aggregated message may be presented instead of the plurality of identical messages. That is, the plurality of identical messages are collapsed, and if there continue to be identical messages subsequently, it is only necessary to increase the number of times of merging messages and add the added user information in the presented aggregated message, so as to improve the in-group information efficiency and avoid missing key information due to messages flooding the screen.

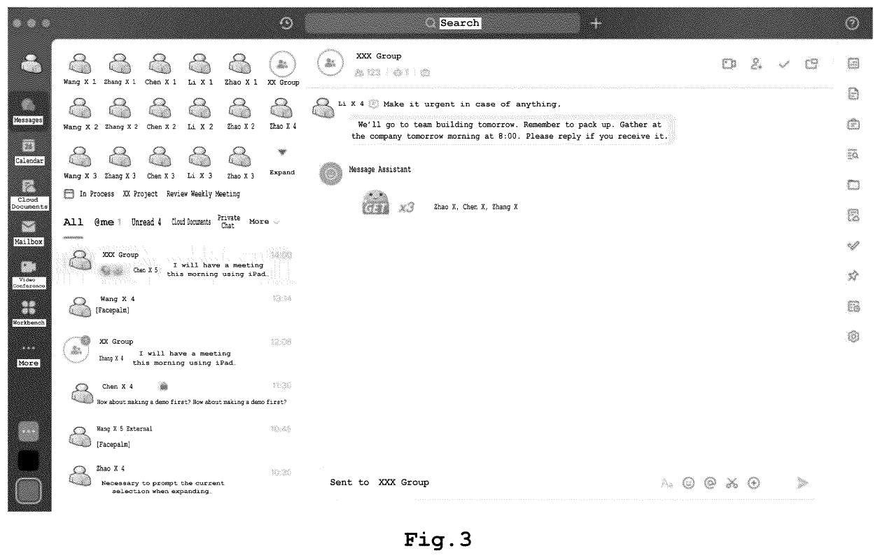

As shown in FIG. 3, when a plurality of users send the emoji “GET”, the contents are collapsed and summarized on a message card for presentation, which shows the number of users who reply and the names of the users who reply.

The message processing method provided in the embodiment of the present application, after receiving messages sent by users in a conversation, makes judgment on the messages, and if a plurality of messages meet an identical-message condition, aggregates the plurality of messages to form an aggregated message including message content, the number of times of merging and user information, and replaces a plurality of identical messages with the aggregated message in the conversation, so that repeated replies from multiple persons among the communication conversation messages can be collapsed into one place and displayed in an aggregated manner, thereby improving the efficiency of in-group information communication and avoiding excessive invalid information.

In some embodiments, if the plurality of messages include only text messages, it is judged whether a plurality of text messages exceeding a threshold contain the same text content; if yes, it is determined that the plurality of messages containing the same text content meet an identical-message condition, and the same text content is taken as message content of the aggregated message corresponding to the plurality of text messages.

Specifically, if a plurality of messages are all text messages, it is judged whether a plurality of text messages sent by users exceeding a threshold contain the same text content, and if they contain the same text, it means that the identical-message condition is met, and the same text is taken as message content of the aggregated message. For example, if a plurality of users reply with multiple “RECEIVED”, the contents will be collapsed and summarized on a message card for presentation. The specific operation is to detect that the messages exceeding the threshold all have the same content, and then such collapse will be enabled.

In some embodiments, if the first text message meeting the identical-message condition includes other content in addition to the same text content, the aggregated message is presented and the first text message is presented.

Specifically, if an identical text message further includes other content, if the message is directly collapsed, important information may be hidden. Therefore, in an embodiment of the present application, when the first text message meeting the identical-message condition includes other content in addition to the same text content, the first text message is still presented while the aggregated message is presented. Specifically, the number of times of messages in the aggregated message is increased by 1, and the first text message is presented. For example, if a user's reply is a paragraph containing reply-related content, along with other content, such as “OK, I'll arrange a meeting to prepare for it later”, the system will detect the key text “OK” as a reply message and summarize it on the card, with the count plus 1; the paragraph of text itself sent by the user will not be collapsed but will be displayed on a chat interface to avoid omission or loss of information. If there continue to appear identical reply-related emojis, texts, or text paragraphs with replies later, they will still be automatically collapsed.

In some embodiments, if the plurality of messages include both text messages and emoji messages, a keyword corresponding to each emoji message is determined;

It is judged whether the text messages contain the same text content, and whether the keyword corresponding to the emoji message is the same as the text content;
or,
the keyword corresponding to the emoji message is determined, and it is judged whether the text messages contain the keyword;

If yes, when the number of the text messages and emoji messages exceeds a threshold, it is determined that the text messages and the emoji messages meet an identical-message condition, and the keyword and/or the emoji message are taken as message content of the corresponding aggregated message.

Specifically, if the messages contain both text messages and emoji messages, it is necessary to judge whether the text messages and the emojis are identical messages, wherein the text messages may be either plain text messages or messages containing both texts and emojis, and the emoji messages are messages containing only emojis. First, it is judged whether the text messages contain the same text content, and then it is judged whether a keyword corresponding to the emoji messages is the same as the text content. If yes, when the number of the text messages and emoji messages exceeds a threshold, it is determined that the emoji messages and the text messages meet the identical-message condition. Alternatively, first, a keyword corresponding to the emoji messages is determined and it is taken as text content corresponding to the emoji messages, the emoji messages are regarded as text messages, and then it is judged whether the text messages contain the keyword. If yes, when the number of the text messages and emoji messages exceeds a threshold, it is determined that the text messages and the emoji messages meet the identical-message condition, and the keyword and/or a first emoji corresponding to the emoji messages are taken as message content of the corresponding aggregated message. That is, if the users' replies contain both texts and emojis, which express the same content meaning, the texts and emojis sent will be collapsed together into the same summary card.

In an embodiment of the present application, a collapse operation may be performed on multiple repeated emojis, texts, mixed emojis and texts, and long texts with reply content among the messages, thereby improving the efficiency of in-group information and avoiding missing key information due to messages flooding the screen.

In some embodiments, after presenting the aggregated message, if a plurality of messages being identical with the previous aggregated message are further received after it is judged that a message interruption condition is met, the plurality of messages further received are re-aggregated to obtain a new aggregated message.

Specifically, when the messages sent by the users are always the same reply message, such as “OK”, and there do not appear any other irrelevant replies, no matter how long the time interval is, the messages will be collapsed into the same summary card until the message interruption condition is met. For example, a new message does not meet the identical-message condition, or the new message contains specific information, or the time interval between the new message and the last message is greater than a preset time-period threshold, etc. For example, someone sends other information, which interrupts the collapse;

When there appear messages with reply related text among the messages, which also contain other text, the collapse is not blocked, the count on the card itself being increased by 1, the text paragraph being not collapsed;

When there appears content that is completely irrelevant to the specified text reply among the messages, the collapse is interrupted, and the reply information that appears later will not be collapsed into the card above; if continuous reply contents further appear after the interruption, they will be collapsed into a new summary card.

In some embodiments, after presenting the aggregated message, when messages meeting the identical-message condition are further received, it is judged whether the message interruption condition is met; if not, the received messages are aggregated into the aggregated message.

Specifically, if after presenting the aggregated message, messages meeting the identical-message condition are further received, it is first judged whether the message interruption condition is met; if not, the received messages are aggregated into the aggregated message; if yes, they are not aggregated.

In some embodiments, in response to a user-triggered aggregated message merging operation, the new aggregated message is merged with the previous aggregated message.

Specifically, message merging options such as “MERGE UP” can be set on an information summary card, and after a user clicks on it, summary information of this card and summary information of the previous card can be merged into one card, with personnel information counted with de-duplication. If the card contents to be merged are inconsistent, a summary of the two kinds of information is displayed, with the personnel information being not de-duplicated.

In an embodiment of the present application, when there appear continuous messages of message content types, the collapse of information will not be interrupted, and the collapse act will be interrupted only when there appears completely irrelevant information. When there is information that interrupts the collapse operation, a plurality of collapsed cards can be manually merged, and data is presented in a merged manner, which facilitates statistics and tracing by administrators.

In some embodiments, the message processing method further comprises presetting at least one keyword corresponding to respective emojis;

If it is detected that text messages entered by the users include a keyword corresponding to a second emoji, the second emoji and the text content corresponding to the text messages are collectively taken as sending message options, so that the users select a corresponding message form to send to the group.

Specifically, each emoji is preset with some associative keywords. For example, regarding the emoji “fireworks”, associative results may be evoked through a plurality of different keywords such as “fireworks”, “festival”, and “celebration”. The users may choose associated emojis to send, or may directly send in a text form. The setting is performed that the users directly enter text to associate emojis therewith, and association may be evoked at any position in a paragraph of text without the need for special characters, which reduces the users' learning cost and makes it more convenient and quick to use.

In some embodiments, detecting that the text messages entered by the users include a keyword corresponding to a second emoji comprises:

With the mouse cursor positioning point as a search cutoff point, searching for text content before the cursor in the messages entered by the users, and matching it sequentially with the associated words corresponding to respective emojis preset in the system; if the matching is successful, determining that the text messages entered by the users include a keyword corresponding to the second emoji that is successfully matched.

In some embodiments, if it is detected that the text messages entered by the users include keywords corresponding to a plurality of second emojis, the plurality of second emojis are provided as sending message options for the users to select.

Specifically, since there are no special characters as the search starting position, it is necessary to perform long-text keyword dynamic detection. With the mouse cursor positioning point as the search cutoff point, a search is made for the text before the cursor, which is sequentially matched with the emoji associated text in the system; a maximum number of matching keywords is set, and with a successive decrease, the matching search is performed. If there appear a plurality of matching results, such as “face with tears of joy” and “smiley face”, the plurality of matching results are displayed on a prompt panel at the same time.

For example, an emoji is preset to be associated with three keywords, the text lengths of which are 4 characters, 3 characters, and 2 characters, respectively. Then based on the current cursor position, four characters forward are determined and matched; if there are no matching results, further three characters forward are determined and matched, and so on. Through long-text keyword dynamic detection, associated emojis may be evoked at any position in a paragraph of text entered, and there is no need to enter special characters, and emoji association presentation can be performed directly.

In some embodiments, there further comprises: if the plurality of messages meeting the identical-message condition include a plurality of messages sent by one and the same user, the number of times of messages corresponding to the plurality of messages sent by the one and the same user is 1.

Specifically, for the convenience of statistics, different messages can be distinguished by user, that is, identical messages sent by one and the same user are counted only once. In this way, if the plurality of messages meeting the identical-message condition include a plurality of messages sent by the one and the same user, the number of times of aggregated messages corresponding to the plurality of messages sent by the one and the same user is 1.

In some embodiments, there further comprises: re-aggregating adjacent aggregated messages.

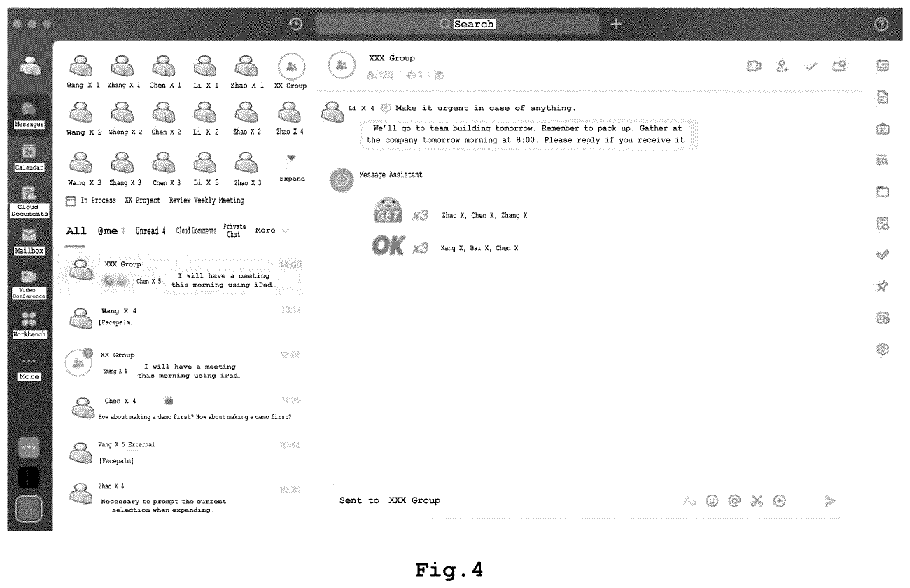

As shown in FIG. 4, if the adjacent messages are adjacent aggregated messages, the adjacent aggregated messages may be re-aggregated to form a card.

First, the message processing method provided in the embodiment of the present application can automatically perform collapsed and aggregated presentation of multiple repeated emojis, texts, mixed emojis and texts, and long texts with reply content among conversation messages, thereby reducing the in-group interference of invalid information and helping to focus on key information. A plurality of pieces of aggregated information may be merged to help administrators conduct data statistics and information collection, reduce workload and improve the working efficiency.

Then, when there appear continuous messages of message content types, the collapse of information will not be interrupted, and the collapse act will be interrupted only when there appears completely irrelevant information; when there is information that interrupts the collapse operation, a plurality of collapsed cards can be manually merged, and data is presented in a merged manner, which facilitates statistics and tracing by administrators.

Finally, by directly entering text, desired emojis may be associated therewith, and the association may occur at any position in a paragraph of text, without the need to enter special characters, thereby reducing the users' learning cost and improving the input efficiency.

It should be noted that the method of the embodiment of the present application can be executed by a single device, such as a computer, a server or the like. The method of this embodiment can also be applied in a distributed scenario and completed by multiple devices cooperating with each other. In the case of this distributed scenario, one of the multiple devices may execute only one or more steps in the method of the embodiment of the present application, and the multiple devices may interact with each other to complete the described method.

It should be noted that some embodiments of the present application are described above. Other embodiments fall within the scope of the appended claims. In some cases, the actions or steps recited in the claims may be performed in an order different from that in the above-described embodiments and still achieve desirable results. In addition, the processes depicted in the figures do not necessarily require the particular order shown, or sequential order, to achieve desirable results. In certain implementations, multitasking and parallel processing are also possible or may be advantageous.

Based on the same technical concept, corresponding to the method of any one of the above embodiments, an embodiment of the present application further provides a message processing apparatus.

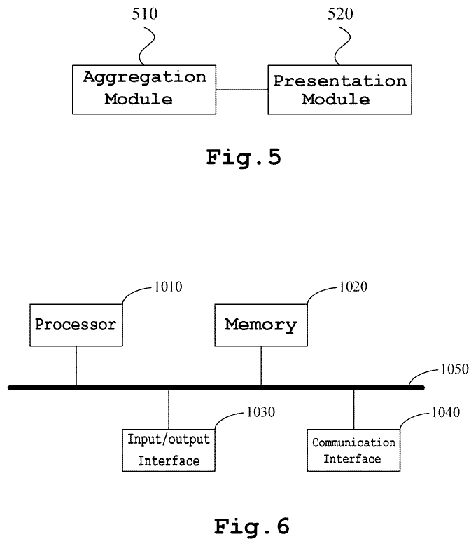

Referring to FIG. 5, the message processing apparatus comprises: an aggregation module 510 and a presentation module 520, wherein:
the aggregation module 510 is configured to, in response to messages sent by users in a conversation, aggregate a plurality of messages meeting an identical-message condition among the messages to form an aggregated message; the presentation module 520 is configured to replace the messages meeting an identical-message condition with the aggregated message in the conversation and present the aggregated message.

In some embodiments, the aggregated message includes one or more of the following:
message content;
the number of the plurality of messages;
user information of the users who send the plurality of messages.

In some embodiments, if the plurality of messages include only text messages, the aggregation module 510 judges whether a plurality of text messages exceeding a threshold contain the same text content; if yes, determines that the plurality of messages containing the same text content meet an identical-message condition, and takes the same text content as message content of the aggregated message corresponding to the plurality of text messages.

In some embodiments, if a first text message meeting an identical-message condition includes other content in addition to the same text content, the presentation module 520 presents the aggregated message and presents the first text message.

In some embodiments, if the plurality of messages include both text messages and emoji messages, the aggregation module 510 determines a keyword corresponding to each emoji message;
judges whether the text messages contain the same text content, and whether the keyword corresponding to the emoji message is the same as the text content; or determines a keyword corresponding to the emoji message, and judges whether the text messages contain the keyword;
if yes, when the number of the text messages and emoji messages exceeds a threshold, determines that the text messages and the emoji messages meet an identical-message condition, and takes the keyword and/or a first emoji corresponding to the emoji messages as message content of the corresponding aggregated message.

In some embodiments, after presenting the aggregated message, if a plurality of messages being identical with the previous aggregated message are further received after the aggregation module 510 judges that a message interruption condition is met, the aggregation module 510 re-aggregates the plurality of messages further received to obtain a new aggregated message.

In some embodiments, after presenting the aggregated message, when messages meeting the identical-message condition are further received, the aggregation module 510 judges whether the message interruption condition is met, and if not, aggregates the received messages into the aggregated message.

In some embodiments, the aggregation module 510 is further configured to:
preset at least one keyword corresponding to respective emojis;
if it is detected that the text messages entered by the users include a keyword corresponding to a second emoji, take the second emoji and the text content corresponding to the text messages collectively as sending message options, so that the users select a corresponding message form to send to the conversation.

In some embodiments, the aggregation module 510 is further configured to:
detect that the text messages entered by the users include a keyword corresponding to a second emoji, which comprises:
with a mouse cursor positioning point as a search cutoff point, searching for the text content before the cursor in the messages entered by the users, and matching it sequentially with the keywords corresponding to the respective emojis preset in the system; if the matching is successful, determining that the text messages entered by the users include the keyword corresponding to the second emoji that is matched successfully.

In some embodiments, the aggregation module 510 is further configured to:
if it is detected that the text messages entered by the users include keywords corresponding to a plurality of second emojis, provide the plurality of second emojis as sending message options for the users to select.

In some embodiments, the aggregation module 510 is further configured to:
in response to a user-triggered aggregated message merging operation, merge the new aggregated message with the previous aggregated message.

In some embodiments, the aggregation module 510 is further configured to:
increase the number of times of messages in the aggregated message by 1, and present the first text message.

In some embodiments, the aggregation module 510 is further configured to:
if the plurality of messages meeting an identical-message condition include a plurality of messages sent by one and the same user, the number of times of messages corresponding to the plurality of messages sent by the one and the same user is 1.

In some embodiments, the aggregation module 510 is further configured to:
re-aggregate adjacent aggregated messages.

In some embodiments, the plurality of messages are all text messages;
or,
the plurality of messages include text messages and emojis.

For the convenience of description, the above apparatus is divided into various modules according to its functions, which are described respectively. Of course, when implementing the present application, the functions of the respective modules may be implemented in the same one or multiple software and/or hardware.

The apparatus of the above embodiment is configured to implement the corresponding message processing method in any one of the above embodiments, and has the beneficial effects of the corresponding method embodiment, which will not be repeated here.

Based on the same technical concept, corresponding to the method of any one of the above-mentioned embodiments, the present application further provides an electronic device, comprising a memory, a processor, and a computer program stored in the memory and executable on the processor, wherein the processor, when executing the program, implements the message processing method described in any one of the above embodiments.

FIG. 6 shows a more specific schematic diagram of the hardware structure of an electronic device provided in this embodiment. The device may comprise: a processor 1010, a memory 1020, an input/output interface 1030, a communication interface 1040 and a bus 1050, wherein the processor 1010, the memory 1020, the input/output interface 1030, and the communication interface 1040 carry out communicative connection to one another within the device via a bus 1050.

The processor 1010 may be realized by a general-purpose Central Processing Unit (CPU), a microprocessor, an application-specific integrated circuit (ASIC), one or more integrated circuits or the like, and is configured to execute relevant programs to implement the technical solutions provided in the embodiments of this specification.

The memory 1020 may be realized in the form of Read Only Memory (ROM), Random Access Memory (RAM), static storage device, dynamic storage device, or the like. The memory 1020 may store an operating system and other applications, and when the technical solutions provided in the embodiments of this specification are implemented by software or firmware, relevant program codes are stored in the memory 1020, and called and executed by the processor 1010.

The input/output interface 1030 is configured to connect to an input/output module to realize information input and output. The input/output module may be configured as a component in the device (not shown in the figure), or may be externally connected to the device to provide corresponding functions. The input device may comprise a keyboard, a mouse, a touch screen, a microphone, various sensors, etc., and the output device may comprise a display, a speaker, a vibrator, an indicator light, etc.

The communication interface 1040 is configured to connect to a communication module (not shown in the figure) to achieve communicative interaction between the device and other devices, wherein the communication module may carry out communication through a wired method (such as USB, network cable, etc.) or a wireless method (such as mobile network, WIFI, Bluetooth, etc.).

The bus 1050 includes a path that transmits information between various components of the device (e.g., the processor 1010, the memory 1020, the input/output interface 1030, and the communication interface 1040).

It should be noted that, although only the processor 1010, the memory 1020, the input/output interface 1030, the communication interface 1040 and the bus 1050 of the above device are shown, in the specific implementation process, the device may further comprise other components necessary for achieving normal operation. In addition, those skilled in the art may understand that the above-mentioned device may comprise only components necessary to implement the solutions of the embodiments of the present specification, and does not necessarily comprise all components shown in the figure.

The electronic device of the above embodiment is configured to implement the corresponding message processing method in any one of the above embodiments, and has the beneficial effects of the corresponding method embodiment, which will not be repeated here.

Based on the same technical concept, corresponding to the method of any one of the above embodiments, an embodiment of the present application further provides a non-transitory computer-readable storage medium that stores computer instructions configured to cause the computer to perform the message processing method described in any one of the above embodiments.

The computer-readable media of this embodiment includes permanent and non-permanent, removable and non-removable media, and information storage can be implemented by any method or technology. The information may be computer-readable instructions, data structures, program modules or other data. Examples of the computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk-read-only memory (CD-ROM), digital versatile disks (DVDs) or other optical storage, magnetic cassettes, magnetic tape, magnetic disk storage or other magnetic storage devices, or any other non-transmission medium that can be used to store information accessible by a computing device.

The storage medium of the above embodiment stores computer instructions used to cause the computer to perform the message processing method described in any one of the above embodiments, and has the beneficial effects of the corresponding method embodiment, which will not be repeated here.

Based on the same technical concept, corresponding to the method of any one of the above embodiments, an embodiment of the present application further provides a computer program product, including computer program instructions which, when executed on a computer, causes a computer to perform the message processing method described in any one of the above embodiments.

Those skilled in the art should understand that the discussion of any one of the above embodiments is merely illustrative and is not intended to imply that the scope of the present application (including the claims) is limited to these examples. In line with the concept of the present application, the technical features in the above embodiments or different embodiments may be combined, the steps may be implemented in any order, and there are many other variations of the different aspects of the embodiments of the present application as described above, which are not provided in detail for the sake of simplicity.

Additionally, well known power/ground connections to integrated circuit (IC) chips and other components may or may not be shown in the provided figures to simplify illustration and discussion, and so as not to obscure the embodiments of the present application. In addition, the devices may be shown in the form of block diagrams in order to avoid making the embodiments of the present application difficult to understand, and this also takes into account the fact that the details of the implementation of these block diagram devices are highly dependent on the platform on which the embodiments of the present application are to be implemented (that is, these details should be fully within the scope of understanding of those skilled in the art). Where specific details (e.g., circuits) are set forth to describe exemplary embodiments of the present application, it will be apparent to one skilled in the art that the embodiments of the present application may be practiced without or with variations in these specific details. Accordingly, the description is to be regarded as illustrative rather than restrictive.

Although the present application has been described in conjunction with specific embodiments thereof, many alternatives, modifications and variations of these embodiments will be apparent to those skilled in the art in light of the foregoing description. For example, other memory architectures, such as dynamic RAM (DRAM), may use the discussed embodiments.

The embodiments of the present application are intended to embrace all such alternatives, modifications and variations that fall within the broad scope of the appended claims. Therefore, any omissions, modifications, equivalent substitutions, improvements, etc. made within the spirit and principles of the embodiments of the present application should be included in the protection scope of the present application.

1. A message processing method, comprising:
in response to messages sent by users in a conversation, aggregating a plurality of messages meeting an identical-message condition among the messages to form an aggregated message;
replacing the messages meeting the identical-message condition with the aggregated message in the conversation and presenting the aggregated message.

2. The method according to claim 1, wherein the aggregated message comprises one or more of:
message content;
the number of the plurality of messages;
user information of the users who send the plurality of messages.

3. The method according to claim 1, wherein if the plurality of messages comprise only text messages, it is judged whether a plurality of text messages exceeding a threshold contain the same text content; if yes, it is determined that the plurality of messages containing the same text content meet the identical-message condition, and the same text content is taken as message content of the aggregated message corresponding to the plurality of text messages.

4. The method according to claim 3, wherein if a first text message meeting the identical-message condition comprises other content in addition to the same text content, the aggregated message is presented and the first text message is presented.

5. The method according to claim 1, wherein if the plurality of messages comprise both text messages and emoji messages, a keyword corresponding to each emoji message is determined;
it is judged whether the text messages contain the same text content, and whether the keyword corresponding to the emoji message is the same as the text content; or, a keyword corresponding to the emoji message is determined, and it is judged whether the text messages contain the keyword;
if yes, when the number of the text messages and emoji messages exceeds a threshold, it is determined that the text messages and the emoji messages meet the identical-message condition, and at least one of the keyword or a first emoji corresponding to the emoji messages are taken as message content of the corresponding aggregated message.

6. The method according to claim 1, wherein after presenting the aggregated message, if a plurality of messages being identical with the previous aggregated message are further received after it is judged that a message interruption condition is met, the plurality of messages further received are re-aggregated to obtain a new aggregated message.

7. The method according to claim 1, wherein after presenting the aggregated message, when messages meeting the identical-message condition are further received, it is judged whether a message interruption condition is met, and if not, the received messages are aggregated into the aggregated message.

8. The method according to claim 1, wherein the method further comprises:
presetting at least one keyword corresponding to respective emojis;
if it is detected that the text messages entered by the users comprise a keyword corresponding to a second emoji, taking the second emoji and the text content corresponding to the text messages collectively as sending message options, so that the users select a corresponding message form to send to the conversation.

9. The method according to claim 8, wherein detecting that the text messages entered by the users comprise a keyword corresponding to a second emoji comprises:
with a mouse cursor positioning point as a search cutoff point, searching for the text content before the cursor in the messages entered by the users, and matching it sequentially with the keywords corresponding to the respective emojis preset in the system; if the matching is successful, determining that the text messages entered by the users comprise the keyword corresponding to the second emoji that is matched successfully.

10. The method according to claim 8, wherein if it is detected that the text messages entered by the users comprise keywords corresponding to a plurality of second emojis, the plurality of second emojis are provided as sending message options for the users to select.

11. The method according to claim 6, further comprising:
in response to a user-triggered aggregated message merging operation, merging the new aggregated message with the previous aggregated message.

12. The method according to claim 4, wherein the aggregated message is presented and the first text message is presented comprise:
increasing the number of times of messages in the aggregated message by 1, and presenting the first text message.

13. The method according to claim 2, further comprising:
if the plurality of messages meeting the identical-message condition comprise a plurality of messages sent by one and the same user, the number of times of messages corresponding to the plurality of messages sent by the one and the same user is 1.

14. The method according to claim 7, further comprising:
re-aggregating adjacent aggregated messages.

15. The method according to claim 1, wherein the plurality of messages are all text messages;
or,
the plurality of messages comprise text messages and emojis.

16. An electronic device, comprising a memory, a processor, and a computer program stored in the memory and executable on the processor, wherein the processor, when executing the program, implements a message processing method, comprising:
in response to messages sent by users in a conversation, aggregating a plurality of messages meeting an identical-message condition among the messages to form an aggregated message;
replacing the messages meeting the identical-message condition with the aggregated message in the conversation and presenting the aggregated message.

17. (canceled)

18. A non-transitory computer-readable storage medium that stores computer instructions, wherein the computer instructions are configured to cause a computer to perform a message processing method, comprising:
in response to messages sent by users in a conversation, aggregating a plurality of messages meeting an identical-message condition among the messages to form an aggregated message;
replacing the messages meeting the identical-message condition with the aggregated message in the conversation and presenting the aggregated message.

19. (canceled)

20. The electronic device according to claim 16, wherein the aggregated message comprises one or more of:
message content;
the number of the plurality of messages;
user information of the users who send the plurality of messages.

21. The electronic device according to claim 16, wherein if the plurality of messages comprise only text messages, it is judged whether a plurality of text messages exceeding a threshold contain the same text content; if yes, it is determined that the plurality of messages containing the same text content meet the identical-message condition, and the same text content is taken as message content of the aggregated message corresponding to the plurality of text messages.

22. The electronic device according to claim 21, wherein if a first text message meeting the identical-message condition comprises other content in addition to the same text content, the aggregated message is presented and the first text message is presented.
